(19) United States
(12) Patent Application Publication
(10) Pub. No.: US 2016/0102206 A1
(43) Pub. Date: Apr. 14, 2016

(54) RESILIENT RENEWABLE COMPOSITES AND METHOD OF MAKING

(71) Applicant: Herman Miller, Inc., Zeeland, MI (US)

(72) Inventor: Lewis Alan Mabon, Holland, MI (US)

(21) Appl. No.: 14/878,122

(22) Filed: Oct. 8, 2015

Related U.S. Application Data
(60) Provisional application No. 62/061,811, filed on Oct. 9, 2014.

(51) Int. Cl. C08L 89/00; C08L 3/02

(52) U.S. Cl. CPC C08L 89/00; C08L 3/02

(57) ABSTRACT

A renewable composite used a structural component in furniture is provided along with a method of making the same. The renewable composite comprises a biodegradable composition capable of receiving and retaining staples and other fasteners. The biodegradable composition includes a mixture of a resilient material and a base resin, wherein the base resin comprises a protein or starch-based resin and one or more strengthening agents. The method comprises providing the base resin, providing the resilient material; mixing the resilient material with the base resin to form a homogeneous mixture of a biodegradable composition; drying or pre-curing the biodegradable composition; and forming a renewable composite in the shape of a structural component. Optionally, the biodegradable composition may be subjected to pre-form molding.

### CROSS-REFERENCE TO RELATED APPLICATIONS

This application claims priority to U.S. Provisional Patent Application No. 62/061,811, filed Oct. 9, 2014, the entire contents of which are incorporated by reference herein.

### FIELD

This disclosure relates generally to biodegradable compositions that are formed into composites used in the construction of furniture and other structural components. More specifically, this disclosure relates to biodegradable composite materials that are suitable for receiving and retaining staples and fasteners.

### BACKGROUND

The statements in this section merely provide background information related to the present disclosure and may not constitute prior art.

Most composites used in the automotive, construction, furniture, and packaging industries are made using petroleum-based fibers and resins. These composites pose a threat to the environment because they are not easily recycled or reused. Thus, at the end of their these composites end up in landfills where they do not degrade for several decades under normal environmental conditions. In addition, since petroleum has become expensive, so have the fibers, resins, and composites formed therefrom.

Fiber reinforced composites that include soy-based bioplastics are viewed as potential substitutes for petroleum-based composites. Natural fibers, such as those obtained from agricultural plants, are attractive ingredients for use in forming these fiber reinforced composites due to their low cost, low density, exceptional strength properties, ease of separation, and biodegradability. However, such fiber reinforced composites are usually dense and exhibit a degree of brittleness that makes it difficult to effectively receive and retain staples or other types of fasteners.

### SUMMARY

A renewable composite used as a structural component in furniture is provided that comprises a biodegradable composition capable of receiving and retaining staples and other fasteners. The biodegradable composition includes a mixture of a resilient material and a base resin that comprises a protein or starch-based resin and one or more strengthening agents.

In the biodegradable composition, the resilient material may be present in the range of 5 wt. % to 50 wt. % and the base resin in the range of 50 wt. % to 95 wt. % relative to the weight of the overall biodegradable composition. The resilient material may be an elastomer or elastomeric filler selected from the group consisting of saturated rubbers, unsaturated rubbers, thermoplastic elastomers, protein elastomers, elastolefins, and mixtures or combination thereof. Examples of saturated rubber include natural rubbers, synthetic isoprene, polybutadiene, chloroprene, butyl rubber, styrene-butadiene rubber, nitrile rubber, or a blend of masticated rubber. Examples of unsaturated rubber include ethylene propylene rubber, ethylene propylene diene rubber, epichlorohydrin rubber, silicone rubber, fluoroelastomers, and ethylene-vinyl acetate. The resilient material can be present in the form of particles, fibers, or sheets. When present as particles, the particles have an average diameter that is in excess of 500 micrometers; less than 200 micrometers; or in the range between 200 and 500 micrometers.

In the base resin, the amount of protein or starch-based resin ranges from 40.0 wt. % to 99.5 wt. % and the amount of strengthening agent in the base resin ranges from 0.5 wt. % to 60.0 wt. % relative to the weight of the overall base resin. Examples of protein elastomers that may be used as the base resin include resilin and elastin. The protein may be a plant-based protein or an animal-based protein with a specific example of a plant-based protein being soy protein. Examples of starch-based resins that may be used include corn starch, wheat starch, tapioca starch, tuber starch, rice starch, and combinations thereof.

In the base resin, the strengthening agent either provides reinforcement by cross-linking with the protein or starch-based resin or acts as reinforcing filler without the occurrence of such cross-linking. The strengthening agent may comprise nanoclay, microfibrillated cellulose, nanofibrillated cellulose, or a natural fiber. Examples of natural fibers include hemp, kenaf jute, ramie, flax, linen, sisal, banana, pineapple, kapok, bamboo, ramie, cellulose, liquid crystalline (LC) cellulose, and any combination or mixture thereof. The strengthening agent may be provided as a reinforcing fiber, a reinforcing filament, a reinforcing yarn, a woven fabric, a knitted fabric, a non-woven fabric, and combinations thereof. According to one aspect of the present disclosure, the strengthening agent may comprise a carboxylic acid or an ester that is capable of forming a crosslink with the protein.

The biodegradable composition may further comprise one or more of a plasticizer, an anti-moisture agent, or an anti-microbial agent. The ratio of the plasticizer to the base resin ranges from 1:4 to 1:20. Examples of the plasticizer include hydrophilic or hydrophobic polyols, carboxyl methyl gum, carboxyl methyl starch and carboxy methyl tamarind, and a combination thereof. The anti-moisture agent may include a plant-based, petroleum-based, or animal-based wax or oil. Several specific examples of the anti-moisture agent include a lignin, a salt of stearic acid, or a stearate ester. The anti-microbial agent may be guanidine polymers, essential oils, parabens, and azoles.

According to another aspect of the present disclosure, a method of forming a renewable composite from a biodegradable composition that is able to receive and retain staples and other fasteners and can be used as a structural component is provided. The method comprises providing a base resin, the base resin comprising a protein or starch-based resin and one or more strengthening agents; providing a resilient material; mixing the resilient material with the base resin to form a homogeneous mixture of a biodegradable composition; drying or pre-curing the biodegradable composition; and forming a renewable composite in the shape of a structural component. Optionally, the biodegradable composition may be subjected to pre-form molding.

The renewable composite may be formed into the shape of the structural component using compression molding. The structural component may be used in furniture or in an office structure. Examples of a structural component include part of a frame for a couch, chair, or recliner, while examples of an office structure include a cubicle wall or bulletin board.

According to another aspect of the present disclosure furniture or an office structure that incorporates a renewable composite formed according to the method described herein is also provided. The renewable composite may be constructed to include a single layer or multiple layers that exhibit areas with greater strength and/or greater toughness in order to accept the fasteners.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a perspective view of a furniture frame made of a renewable composite formed according to the teachings of the present disclosure;

FIG. 1B is a perspective view of a renewable composite in the form of the furniture frame of FIG. 1A with upholstery attached thereto; and

FIG. 2 is a schematic representation of a method used to form the renewable composite of FIGS. 1A and 1B.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to biodegradable compositions that may be formed into composites that are used in the construction of furniture and other structural components. These biodegradable compositions generally comprise a resilient material and a base resin, among other alternative constituents. The resilient material is mixed into the base resin to create a composite of a biodegradable composition.

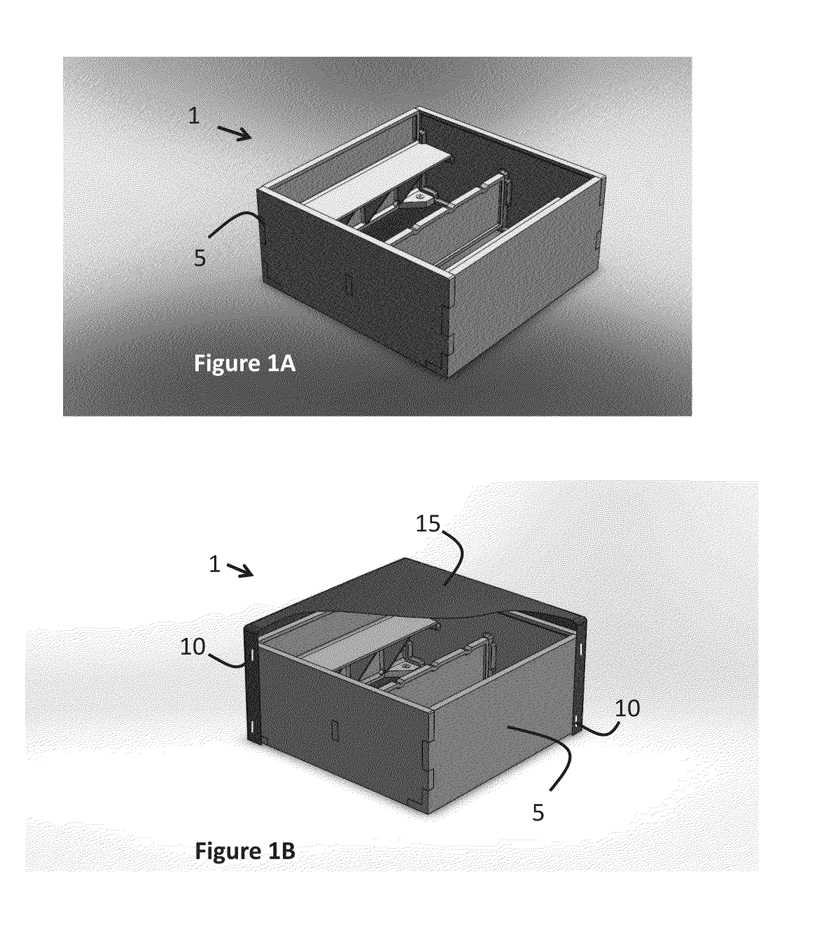

Referring to FIGS. 1A and 1B, the biodegradable composition is formed into a renewable composite 5, which in this form is illustrated as a furniture frame 1, that is suitable for receiving and retaining staples and other fasteners 10. The renewable composite 5 formed from the biodegradable composition and used according to the teachings contained herein is described throughout the present disclosure in conjunction with an upholstered furniture frame 1 in order to more fully illustrate the concept. The incorporation and use of the biodegradable composition in conjunction with other types of structural components is contemplated to be within the scope of the disclosure, and thus the illustration and description of a furniture frame 1 should not be construed as limiting the scope of the present disclosure.

The biodegradable composition of the present disclosure offers a renewable composite 5 material that is especially suited for receiving and retaining staples and other fasteners 10, such as those used to hold upholstery 15 in place. Most wood or wood-like composites, due to their density and brittleness, resist the insertion and retention of staples or fasteners 10. The biodegradable composition of the present disclosure improves the resiliency and toughness of the composite 5, while maintaining flexural strength properties. In other words, the resilient material provides the biodegradable composition with a higher degree of ductility or elasticity than is present in the base resin without compromising the overall strength of the renewable composite 5. Alternatively, the flexural strength of the biodegradable composition is slightly less than the flexural strength of a composite having the same composition without the resilient material. The term slightly less may be defined as less than about a 25% change; alternatively, less than about a 15% change; alternatively, less than about a 10% change.

The term “green” as used herein refers to organic compositions that are non-toxic, biodegradable, and renewable. However, one skilled in the art will understand that certain inorganic minerals, which are non-toxic and can be used without adverse impact to the ecosystem, may also be used without exceeding the scope of the present disclosure.

The term “biodegradable” as used herein refers to compositions that are degradable over time by water and/or enzymes found in nature, without any harmful effect on the environment. The compositions of the present disclosure exhibit properties that meet the requirements of ASTM D6868-11 “Standard Specification for Labeling of End Items that Incorporate Plastics and Polymers as Coatings or Additives” (ASTM International, West Conshohocken, Pa.). Alternatively, the compositions of the present disclosure exhibit properties that meet the requirements of ASTM D6400-04—“Specification for Compostable Plastics” (ASTM International, West Conshohocken, Pa.).

The term “strengthening agent” as used herein describes a material that when incorporated into a biodegradable composition improves one or more of the characteristic(s) of the composite formed therefrom as compared to the characteristic(s) exhibited by a similar composite formed using a composition without the strengthening agent. These characteristic(s) may include without limitation, stress at maximum load, fracture stress, fracture strain, modulus, or toughness.

The resilient material may be an elastomer or elastomeric filler in order to provide the ductility and toughness necessary to accept fasteners. These elastomers may be selected as one from the group of saturated rubbers, unsaturated rubbers, thermoplastic elastomers, protein elastomers, elastolefins, and combinations or mixtures thereof. Several examples of saturated rubbers include, without limitation, natural rubbers, synthetic isoprene, polybutadiene, chloroprene, butyl rubber, styrene-butadiene rubber, and nitrile rubber. Several examples of unsaturated rubbers may include, but not be limited to, ethylene propylene rubber, ethylene propylene diene rubber, epichlorohydrin rubber, silicone rubber, fluoroelastomers, and ethylene-vinyl acetate. Several specific examples of protein elastomers include resilin and elastin, among others.

According to another aspect of the present disclosure, the resilient material may also be a form of a recycled elastomer or rubber. For example, the resilient material may be a blend of “masticated” rubber, which may include uncured natural rubber (NR)/styrene butadiene rubber (SBR) waste from tire manufacturers and rubber processors, ground up vulcanized tire rubber and fiber from recycled scrap tires, or various other ground rubber and fiber materials.

The resilient material may be present in the form of particles, fibers, or sheets. The particles may vary in size from very large particles with an average diameter in excess of 500 micrometers (μm) to small particles with an average diameter that is less than about 200 μm. Alternatively, the particles may be large particles having an average diameter in the range of 200 μm to 500 μm. The fibers, when present, may be textile fibers or recycled rubber fibers, to name a few.

The base resin in the biodegradable composition is substantially or completely soluble in water at a pH of about 7.0 or higher. The amount of resilient material in the biodegradable composition may range from about 5 wt. % to about 50 wt. % relative to the weight of the overall biodegradable composition. Alternatively, the amount of resilient material is about 10 wt. % to about 40 wt. %; alternatively about 15 wt. % to about 35 wt. %. The amount of base resin in the biodegradable composition may range from about 50 wt. % to about 95 wt. % relative to the weight of the overall biodegradable composition. Alternatively, the amount of base resin is about 60 wt. % to about 90 wt. %; alternatively about 65 wt. % to about 85 wt. %.

The base resin generally comprises a plasticized or unplasticized cured protein or starch-based resin and one or more green strengthening agents. The amount of the protein or starch-based resin may range from about 99.5 wt. % to about 40.0 wt. % relative to the weight of the overall base resin, while the amount of the green strengthening agent(s) may range from about 0.5 wt. to about 60.0 wt. % relative to the weight of the overall base resin.

The protein may be a plant-based protein obtained from seeds, stalks, fruits, roots, husks, stover, leafs, stems, bulbs, flowers, algae, or mixture thereof that are either naturally occurring or bioengineered. The plant-based protein when obtained from seeds may be canola or sunflower protein. The plant-based protein when obtained from grains may be rye, wheat, or corn protein.

According to another aspect of the present disclosure, the plant-based protein is soy protein. Soy protein generally contains about 20 different amino acids that include reactive groups, such as —COOH, —NH₂, and —OH groups. Soy protein can self-crosslink through the —SH groups that are present in the cysteine amino acid and through dehydroalanine (DHA) residues. In addition to self-crosslinking, the reactive groups can be utilized to modify the soy proteins in order to improve the mechanical and physical properties of the soy resin. Soy proteins may be modified by the addition of crosslinking agents and internal plasticizers, blending with other resins, and forming interpenetrating networks (IPN) with other cross-linked systems.

The protein that is suitable for use in the present disclosure may also include animal-based proteins, such as collagen, gelatin, casein, albumin, silk and elastin. The protein may also be one that is produced by microorganisms, such as algae, bacteria and fungi or yeast.

The starch-based resins are carbohydrates that comprise a large number of glucose units joined together by glycosidic bonds. The starch-based resins may be selected from the group consisting of corn starch, wheat starch, tapioca starch, tuber starch, rice starch, and combinations thereof. The tuber starch may be selected from potato starch, sweet potato starch, yam starch, cassava starch and mixtures thereof. Alternatively, the starch-based resins may be glycol stearate containing starch-based resins.

One skilled in the art will understand that the strengthening agent may provide reinforcement by cross-linking with the protein or starch-based resin, as well as acting as reinforcing filler without the occurrence of any cross-linking. Several examples of strengthening agents that are capable of cross-linking include carbodiimides, hydroxysuccinamide esters, or hydrazide. The strengthening agent may also be an aldehyde, such as formaldehyde or acetaldehyde; a dialdehyde, such as glutaraldehyde or glyoxal; a polyphosphate, such as sodium pyrophosphate; a polyethylene or polypropylene emulsion; or an ethylene-acrylic acid copolymer.

Alternatively, the green strengthening agent may comprise, without limitation, nanoclay, microfibrillated cellulose, nanofibrillated cellulose, cured green polysaccharide, green reinforcing fibers, filaments, yarns, parallel arrays thereof, woven fabric, knitted fabric and/or non-woven fabric of green polymer(s) different from cured soy protein, and any combinations thereof. Alternatively the green strengthening agent may be cured green polysaccharide. The strengthening agent may also be selected from the group comprising carageenan, agar, gellan, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum, galactans, agaropectin and mixtures thereof. Alternatively, the polysaccharide may be extracted from seaweed and other aquatic plants. Alternatively, the polysaccharide is agar.

According to another aspect of the present disclosure, the strengthening agent may be, but not limited to, a nanoclay, microfibrillated cellulose, nanofibrillated cellulose, or a natural fiber selected from the group consisting of hemp, kenaf, jute, ramie, flax, linen, sisal, banana, pineapple, kapok, bamboo, ramie, cellulose, liquid crystalline (LC) cellulose, and any combination or mixture thereof. The strengthening agent may also be selected from the group comprising a reinforcing fiber, a reinforcing filament, a reinforcing yarn, a woven fabric, a knitted fabric, a non-woven fabric, and combinations thereof. Alternatively, the strengthening agent comprises a plurality of reinforcing fibers that are formed into a mat or sheet.

According to yet another aspect of the present disclosure, the strengthening agent comprises a carboxylic acid or ester that is capable of forming a crosslink with the protein. Several specific examples of carboxylic acids or esters that are useful as a strengthening agent include caproic acids, caproic esters, castor bean oil, fish oil, lactic acids, lactic esters, poly L-lactic acid (PLLA) and polyols. In still another aspect, the strengthening agent is a polymer or a biopolymer, such as lignin, gelatin, or another suitable protein gel, to name a few.

When the strengthening agent is nanoclay, it may have a dry average particle size that is less than about 2 μm, alternatively, less than about 1 μm, alternatively, less than about 0.5 μm. As used herein, the term “nanoclay” means clays that comprise silicate platelets. The base resins that incorporate nanoclay are characterized as green because the nanoclay particles are natural and decompose to soil particles when disposed of or composted. Although the nanoclay does not take part in crosslinking with the protein in the biodegradable composition, it provides reinforcement as a reinforcing additive and filler. The nanoclay may be natural clay selected from the group comprising montmorillonite, fluorohectorite, laponite, bentonite, beidellite, hectorite, saponite, nontronite, sauconite, vermiculite, ledikite, nagadiite, kenyaite and stevensite.

When the strengthening agent is microfibrillated cellulose (MFC), it may be manufactured by separating (shearing) the cellulose fibrils from several different plant varieties. Nanofibrillated cellulose (NFC) may be produced by further purification and shearing of the MFC. The base resins that incorporate MFC or NFC are characterized as being green because MFC and NFC will degrade in moist environments via microbial activity. Although MFC and NFC will not crosslink with the protein in a biodegradable composition, the MFC or NFC can be uniformly dispersed in the biodegradable composition and, due to their size and aspect ratio, effectively act as a reinforcement.

The biodegradable composition may optionally comprise a plasticizer. Without wanting to be bound by any particular theory, it is believed that the addition of a plasticizer increases the strength and rigidity of the composite by reducing the brittleness of the cross-linked protein or starch-based resin. The ratio of the plasticizer to the base resin (starch/protein+strengthening agent) may range from about 1:20 to about 1:4. Alternatively, the ratio of the plasticizer to base resin is 1:4.

Suitable plasticizers for use in the biodegradable composition include hydrophilic or hydrophobic polyols, such as C₁₋₃ polyols, e.g., glycerol, or C₄₋₇ polyols, e.g., sorbitol. Alternatively, the plasticizer is selected from the group comprising carboxyl methyl gum, carboxyl methyl starch and carboxy methyl tamarind or a combination thereof.

The biodegradable composition may also optionally comprise an anti-moisture agent that inhibits moisture absorption by the renewable composite. This anti-moisture agent may also decrease any odors that result from the use of proteins. The anti-moisture agent may be any known wax or oil. Alternatively, the anti-moisture agent is a plant-based, petroleum-based, or animal-based wax or oil. The plant-based anti-moisture agent may be selected from the group comprising carnauba wax, tea tree oil, soy wax, soy oil, lanolin, palm oil, palm wax, peanut oil, sunflower oil, rapeseed oil, canola oil, algae oil, coconut oil, and carnauba oil. The petroleum-based anti-moisture agent may be selected from the group comprising paraffin wax, paraffin oil and mineral oil. The animal-based anti-moisture agent may be selected from the group comprising beeswax and whale oil.

According to another aspect of the present disclosure, the anti-moisture agent is a lignin, such as lignosulfonate; a salt of stearic acid, such as sodium stearate or calcium stearate; or a stearate ester, such as polyethylene glycol stearate, methyl stearate, ethyl stearate, propyl stearate, butyl stearate, octyl stearate, iso-propyl stearate, or myristyl stearate.

The biodegradable composition may also optionally comprise an anti-microbial agent. This antimicrobial agent may be a guanidine polymer. The antimicrobial agent may also be selected from the group comprising essential oils such as tea tree oil, sideritis, oregano oil, mint oil, sandalwood oil, clove oil, nigella sativa oil, onion oil, leleshwa oil, lavendar oil, lemon oil, eucalyptus oil, peppermint oil, cinnamon oil, and thyme oil. Alternatively, the antimicrobial agent is selected from parabens; paraben salts; quaternary ammonium salts, such as n-alkyl dimethylbenzyl ammonium chloride or didecyldimethyl ammonium chloride; allylamines; echinocandins; polyene antimycotics; azoles; isothiazolinones; imidazolium; sodium silicates; sodium carbonate; sodium bicarbonate; sulfite salts, such as sodium or potassium sulfite; bisulfite salts, such as sodium or potassium bisulfite; metabisulfite salts, such as sodium or potassium metabisulfite; benzoic acid; benzoate salts, such as sodium or potassium benzoate; potassium iodide; silver; copper; sulfur; grapefruit seed extract; lemon myrtle; olive leaf extract; patchouli; citronella oil; orange oil; pau d'arco; and neem oil.

According to another aspect of the present disclosure, the parabens may be selected from the group comprising methyl, ethyl, butyl, isobutyl, isopropyl, and benzyl paraben or salts thereof. The azoles may be selected from the group comprising imidazoles, triazoles, thiazoles, and benzimidazoles. Alternatively, the anti-microbial agent is boric acid, or a salt thereof, such as sodium borate, sodium tetraborate, disodium tetraborate, potassium borate, potassium tetraborate, and the like. The anti-microbial agent may also be a pyrithione salt, such as zinc pyrithione or sodium pyrithione.

Further examples of the base resin and additives that may be included in addition to the protein or starch-based resin and the strengthening agent(s) are provided in U.S. Pat. Nos. 8,182,918 and 8,557,367, as well as in U.S. Publication Nos. 2008/0090939, 2009/0042003, 2010/0291822, 2011/0033671, 2011/0271616, 2011/0272856, and 2011/0293876, the contents of which are hereby incorporated in their entirety by reference.

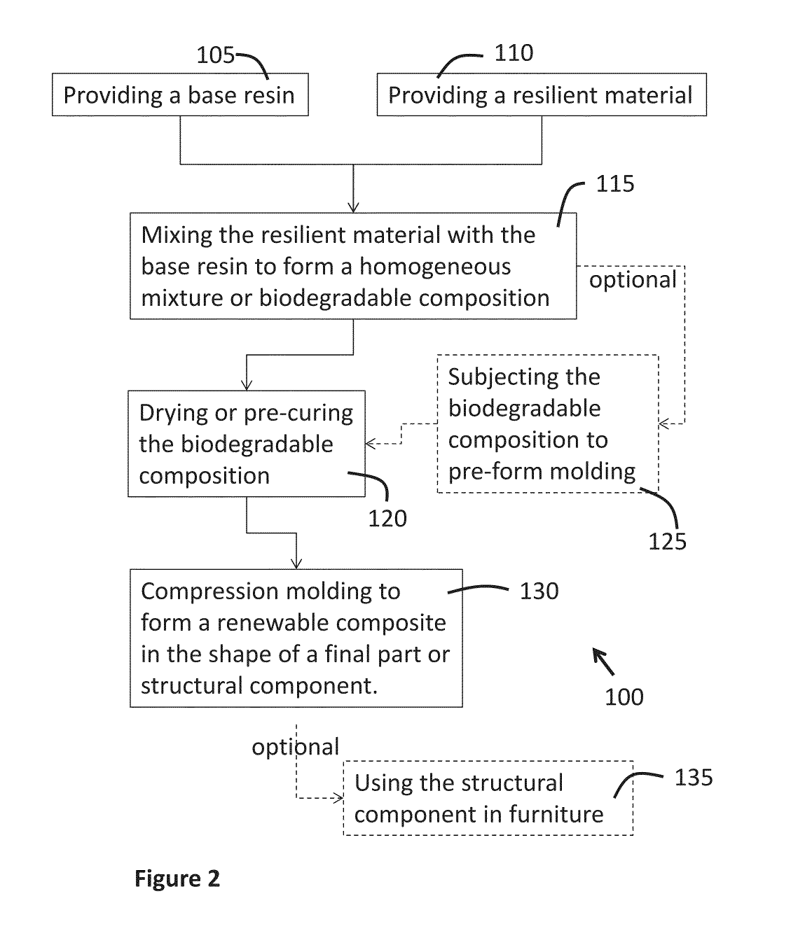

Referring now to FIG. 2, a method 100 of forming a renewable composite from a biodegradable composition is provided. This method 100 generally comprises providing in step 105 a base resin, wherein the base resin comprises a protein or soy-based resin and a strengthening agent; providing in step 110 a resilient material; and mixing 115 the resilient material with the base resin to form a mixture of a biodegradable composition. Alternatively, the mixture is homogeneously mixed. The resilient material may be mixed with the base resin either in liquid or powder form using a rotary mixer or blended in a nonwoven machine. The biodegradable composition may then be dried or pre-cured in step 120 prior to molding. Drying (or pre-curing) can be done with or without temperature. When desirable, drying is done at a predetermined temperature to speed up the process. Typically the temperature of the dried material is no more than 100° C. due to evaporative cooling, while the temperature of the drying air (as an example) might be about 200° C. or more. Optionally, the biodegradable composition may be subjected to pre-form molding step 125 prior to being dried or pre-cured 120. The biodegradable composition is then subjected to a compression molding step 130 to form a renewable composite that is formed into the shape of a final part or structural component The renewable composite can be constructed to include a single layer or multiple layers that exhibit areas with greater strength and/or greater toughness in order to accept fasteners. When desirable, the multiple layers may be bonded together, alternatively, the multiple layers are bonded together by the base resin.

Still referring to FIG. 2, the renewable composites that are comprised of the biodegradable compositions formed in step 130 into the shape of parts or structural components can be incorporated in step 135 into furniture used in the home or in an office, or other environment. The type of furniture may include, without limitation, tables, desks, chairs, couches, shelving, buffets, wet bars, benches, chests, vanities, stools, dressers, bed frames, futon frames, baby cribs, entertainment stands, and bookcases. Alternatively, this furniture may include couches, love seats, arm chairs, or recliners that contain frames formed from the renewable composites that comprise the biodegradable composition. The renewable composites may also be formed into a structure that can be used in an office setting, such as cubicle walls or bulletin boards. These cubicle walls or bulletin boards may exhibit variable densities in order to accommodate the use of push pins or staples.

The specific embodiments of the present disclosure are given to illustrate the design and use of renewable composites formed using the biodegradable compositions according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A renewable composite used as a structural component in furniture, the renewable composite comprising a biodegradable composition that includes a mixture of a resilient material and a base resin, the base resin comprising a protein or starch-based resin and one or more strengthening agents;
wherein the renewable composite is able to receive and retain staples and other fasteners.

2. The renewable composite according to claim 1, wherein the biodegradable composition includes the resilient material in the range of 5 wt. % to 50 wt. % and the base resin in the range of 50 wt. % to 95 wt. % relative to the weight of the overall biodegradable composition.

3. The renewable composite according to claim 1, wherein the resilient material is an elastomer or elastomeric filler selected from the group consisting of saturated rubbers, unsaturated rubbers, thermoplastic elastomers, protein elastomers, elastolefins, and mixtures or combination thereof.

4. The renewable composite according to claim 3, wherein the saturated rubber is selected from the group consisting of natural rubbers, synthetic isoprene, polybutadiene, chloroprene, butyl rubber, styrene-butadiene rubber, nitrile rubber, or a blend of masticated rubber.

5. The renewable composite according to claim 3, wherein the unsaturated rubber is selected from the group consisting of ethylene propylene rubber, ethylene propylene diene rubber, epichlorohydrin rubber, silicone rubber, fluoroelastomers, and ethylene-vinyl acetate.

6. The renewable composite according to claim 3, wherein the protein elastomers are resilin or elastin.

7. The renewable composite according to claims 1, wherein the resilient material is present in the form of particles, fibers, or sheets.

8. The renewable composite according to claim 7, wherein the particles have an average diameter that is in excess of 500 micrometers; less than 200 micrometers; or in the range between 200 and 500 micrometers.

9. The renewable composite according to claim 1, wherein the protein is a plant-based protein or an animal-based protein, and the starch-based resin is selected as one from the group of corn starch, wheat starch, tapioca starch, tuber starch, rice starch, and combinations thereof.

10. The renewable composite according to claim 8, wherein the plant-based protein is soy protein.

11. The renewable composite according to claim 1, wherein the strengthening agent either provides reinforcement by cross-linking with the protein or starch-based resin or acts as a reinforcing filler without the occurrence of such cross-linking.

12. The renewable composite according to claim 1, wherein the strengthening agent comprises nanoclay, microfibrillated cellulose, nanofibrillated cellulose, or a natural fiber selected from the group consisting of hemp, kenaf, jute, ramie, flax, linen, sisal, banana, pineapple, kapok, bamboo, ramie, cellulose, liquid crystalline (LC) cellulose, and any combination or mixture thereof.

13. The renewable composite according to claim 1, wherein the strengthening agent is selected from the group of a reinforcing fiber, a reinforcing filament, a reinforcing yarn, a woven fabric, a knitted fabric, a non-woven fabric, and combinations thereof.

14. The renewable composite according to claim 1, wherein the strengthening agent comprises a carboxylic acid or an ester that is capable of forming a crosslink with the protein.

15. The renewable composite according to claim 1, wherein the biodegradable composition further comprises one or more of a plasticizer, an anti-moisture agent, or an anti-microbial agent.

16. The renewable composite according to claim 15, wherein the ratio of the plasticizer to the base resin ranges from 1:4 to 1:20;
wherein the plasticizer is one selected from the group of hydrophilic or hydrophobic polyols, carboxyl methyl gum, carboxyl methyl starch and carboxy methyl tamarind, and a combination thereof;
wherein the anti-moisture agent is a plant-based, petroleum-based, or animal-based wax or oil, or wherein the anti-moisture agent is a lignin, a salt of stearic acid, or a stearate ester; and
wherein the anti-microbial agent is selected as one from the group of guanidine polymers, essential oils, parabens, and azoles.

17. The renewable composite according to claim 1, wherein the amount of protein or starch-based resin in the base resin ranges from 40.0 wt. % to 99.5 wt. % and the amount of strengthening agent in the base resin ranges from 0.5 wt. % to 60.0 wt. % relative to the weight of the overall base resin.

18. A method of forming a renewable composite from a biodegradable composition for use as a structural component, the method comprising:
providing a base resin, the base resin comprising a protein or starch-based resin and one or more strengthening agents.
providing a resilient material;
mixing the resilient material with the base resin to form a homogeneous mixture of a biodegradable composition;
optionally subjecting the biodegradable composition to pre-form molding;
drying or pre-curing the biodegradable composition; and
forming a renewable composite in the shape of a structural component;
wherein the renewable composite is able to receive and retain staples and other fasteners.

19. The method of claim 18, wherein the renewable composite is formed into the shape of the structural component using compression molding;
wherein the structural component is used in furniture or in an office structure, wherein the structural component is part of a frame for a couch, chair, or recliner, and the office structure is a cubicle wall or bulletin board; and
wherein the renewable composite is constructed to include a single layer or multiple layers that exhibit areas with greater strength and/or greater toughness in order to accept the fasteners.

20. Furniture or an office structure that incorporates a renewable composite formed according to the method of claim 18.
